(19) United States
(12) Patent Application Publication
(10) Pub. No.: US 2015/0135784 A1
(43) Pub. Date: May 21, 2015

(54) SYSTEMS AND METHODS FOR PRODUCING FERTILIZERS BASED ON FISH

(71) Applicant: Iain Milnes, Fremont, CA (US)

(72) Inventor: Iain Milnes, Fremont, CA (US)

(21) Appl. No.: 14/085,895

(22) Filed: Nov. 21, 2013

(51) Int. Cl. C05F 1/00

(52) U.S. Cl. CPC C05F 1/002
USPC 71/9; 435/290.2

(57) ABSTRACT

Systems and methods are disclosed for forming a fertilizer based on fish by decomposing or grinding fish parts into a fish paste; depositing the fish paste into a tank; injecting air into the tank to form bubbles to agitate the fish paste and to accelerate decomposition of the fish paste; and fermenting the fish paste to form the fertilizer.

### BACKGROUND

The present invention relates to systems and methods for producing fertilizers based on fish.

Conventionally, soil additives and plant fertilizers have been made synthetically from petroleum by-products and mineral salts. Chemical fertilizers do not contain the micronutrients and macronutrients found in organic fertilizers. As such, chemical fertilizers can treat only plants but not the soil. Also, chemical fertilizers may kill important soil organisms and tend to be readily leached from the soil, as they are usually composed of water soluble inorganic compounds that are easily washed away. Thus, chemical fertilizers are not retained long enough to have a significant effect on plant growth, while the chemicals leached from the soil can cause environmental damage, by pollution of nearby bodies of water.

Due to the trend to environmental sustainability, people have tried to produce fertilizer from waste food products and waste fish parts. Conventional fish fertilizer has been produced in two ways: (a) the formation of a fish emulsion; and (b) the hydrolysis of whole fish or fish parts to produce hydrolyzed fish fertilizer.

U.S. Pat. No. 4,126,439 discloses a fertilizer product that uses a fish emulsion encased in a water soluble capsule. The fertilizer product is prepared by concentrating the fish emulsion to evaporate most of the water found therein such that the emulsion will not cause the water soluble capsule to dissolve. To this concentrate, is added a liquefying agent and a surfactant which are blended and placed within the capsule. U.S. Pat. 7,678,171 discloses fish emulsion, whole fish or fish by-products are heated to extract oils and the solid material is pressed into a cake and dried to make fish meal, which can then be used for livestock feed. The liquid residue that has been pressed out of the fish cake is the fish emulsion used for fertilizer. There are two main drawbacks associated with fish emulsion fertilizer. Fish emulsion has a very strong, unpleasant odor due to the presence of decomposing proteins, caused by the high temperatures used during the fish extraction process. As fish emulsion is composed of the liquid pressed out of the fish cake, fish emulsion is primarily composed of water soluble nutrients and contains a relatively low concentration of oil-soluble nutrients. Therefore, fish emulsion is lacking in a number of macro and micro nutrients including oils, proteins and vitamins that are beneficial for optimal plant and soil health.

The second method of preparing fertilizer from fish involves the hydrolysis of whole fish or fish parts to produce hydrolyzed fish fertilizer. In this method, the starting material is ground into meal and then digested or hydrolyzed. There are numerous methods of hydrolyzing fish protein to break down solid fish into a liquid form, which fall into two categories: (1) enzymatic hydrolysis and (2) chemical digestion.

Fertilizer produced by the fish hydrolysis process has a number of advantages over fertilizer produced by the fish emulsion process. The hydrolysis process retains much more of the nutrients than the emulsion process, as the hydrolysate utilizes all of the starting material. In particular, hydrolyzed fish fertilizer retains the oil soluble nutrients which are excluded from fish emulsion. Therefore, hydrolyzed fish fertilizer provides superior results to fish emulsion fertilizer, as it contains the full spectrum of nutrients. Hydrolyzed fish fertilizer contains essential oils, vitamins, trace minerals, enzymes, and amino acids, which feed important soil organisms and are taken up more easily by the plant roots. Another advantage of the hydrolysis process is that it usually does not involve high temperatures. Consequently, the hydrolysate has very low odour as it does not contain decomposing proteins.

Enzymatic hydrolysis of fish can be carried out using preparations of enzymes such as papain, which break down proteins into smaller peptides and individual amino acids. However, enzymes are sensitive to pH and temperature, as well as the presence of inhibitors and denaturants. Enzymes will catalyze reactions only within a specific pH and temperature range. Therefore, the hydrolysis reaction must be carefully monitored and controlled. As enzymes must be isolated and refined from natural sources without destroying their catalytic activity, this further increases the manufacturing cost. Enzymatic hydrolysis of fish can also be carried out with microorganisms, e.g. anaerobic digestion as disclosed in U.S. Pat. No. 4,022,665 and U.S. Pat. No. 4,975,106. Hydrolysis of fish protein can also be done with chemicals. However, due to the strength of the peptide bond, stringent conditions, i.e. concentrated acid or base and heat are usually required to completely hydrolyze the fish protein. However, as noted above, the application of heat causes the decomposition of fish protein, which produces unpleasant odors. Moreover, the application of heat to fish protein generally results in a reduction in the concentration of micronutrients such as molybdenum.

U.S. Pat. No. 5,354,349 discloses a continuous method for manufacturing of organic fertilizers by fermentation of a waste (cow manure) containing organic materials or mixture of the waste with cellulose-containing organic materials in the presence of thermophilic and aerobic microorganisms.

### SUMMARY

In one aspect, systems and methods are disclosed for forming a fertilizer based on fish by decomposing or grinding fish parts into a fish paste; depositing the fish paste into a tank; injecting air into the tank to form bubbles to agitate the fish paste and to accelerate decomposition of the fish paste; and fermenting the fish paste to form the fertilizer.

In another aspect, a system to make fertilizer based on fish includes a food compost machine to receive fish parts, mix the fish parts with a base of bio-chips, and facilitate growth of micro-organisms with the bio-chips and oxygen, said food compost machine forming a fish paste; and an aerator receiving the fish paste from the food compost machine, said aerator injects air bubbles to agitate the fish paste and to accelerate decomposition of the fish paste into the fertilizer based on fish.

In yet another aspect, a system to make fertilizer based on fish includes a grinder to receive fish parts and form a fish paste there from; and an aerator receiving the fish paste from the food compost machine, said aerator injects air bubbles to agitate the fish paste and to accelerate decomposition of the fish paste into the fertilizer based on fish.

In implementations, multiple aerator tanks can be connected in parallel or in series so that the process is one of continuous fermentation where the ground fish is always put into the first tank in series.

Advantages of the above embodiments may include one or more of the following. The system creates fertilizer from fish (whole or parts) by grinding to a paste and decomposing in the presence of large volumes of oxygen introduced to a tank with an aerator or micro-bubble generator. The resulting fertilizer from fish is highly concentrated, yet retains the natural micro and macro nutrients of the fish, that is organic as defined by the United States Department of Agriculture (USDA), and which happens as quickly as possible. The system for creating fish fertilizer is advantageous in that the fish is fully decomposed with small particles in the liquid, and the resulting fertilizer is highly concentrated to reduce transportation cost. The use of an aerator or micro-bubble generator: (i) provides large amounts of oxygen to the fermentation process so that the fermentation occurs as rapidly as possible; (ii) mixes the liquid to ensure that fish, microorganisms, and oxygen are widely distributed; and (iii) obviates the need for a separate mechanical agitator to prevent sediment from accumulating on the bottom of the tank. The system converts waste organic materials such waste fish to produce plant and soil fertilizers. Such fertilizers are relatively cheap to produce, and are also environmentally friendly, as they are made from a renewable resource, rather than non-renewable petroleum products. Another important advantage of such fertilizers over petroleum-based fertilizers is that they can improve the health of the soil, which in turn improves the health and yield of the plants. Organic fertilizers contain micronutrients and macronutrients that are not found in chemical fertilizers. The most important nutrients are nitrogen, phosphorus, and potassium. Secondary macronutrients include calcium, magnesium and sulfur. Micronutrients are elements essential for plant growth that are required in trace quantities. Important micronutrients include boron, copper, iron, chloride, manganese, molybdenum and zinc. In addition to these essential elements, “organic” fertilizers (that is, not petroleum-based or otherwise chemical fertilizers) contain amino acids that aid plant and soil health. Organic fertilizers replenish the nutrient level of the soil and feed important soil organisms, such as nematodes, earthworms, and microorganisms, which are essential for overall plant and soil health.

### BRIEF DESCRIPTION OF THE DRAWINGS

FIGS. 1-7 show exemplary embodiments used to make fish fertilizers.

FIG. 8 shows an exemplary process for making fertilizer from fish.

### DESCRIPTION

While the invention is susceptible to various modifications and alternative forms, specific aspects thereof has been shown by way of example in the illustrative examples and will be described in detail below. It should be understood, however that it is not intended to limit the invention to the particular forms disclosed, but on the contrary, the invention is to cover all modifications, equivalents, and alternatives falling within the spirit and the scope of the invention as defined by the appended claims.

An efficient system for making fertilizer from fish by-products is provided. A type of organic fertilizer is fertilizer produced from fish or fish by-products, which utilizes whole fish or fish parts left over from food processing. The use of the term “fish” throughout the application will be used to refer to whole fish, fish parts, or by-products of fish processing, unless stated otherwise. For example, the word “fish” means whole fish or less than the whole fish (for example, head, guts, and bones) that may remain after the some parts of the fish (for example, filets) are removed by some other process. The various ways of making the fertilizer based on fish can be modified in preferred embodiments. However, such modification should be construed within the scope and spirit of the preferred embodiments. Accordingly, the examples are showing only those specific details that are pertinent to understanding the aspects of the present invention so as not to obscure the disclosure with details that will be readily apparent to those of ordinary skill in the art having benefit of the description herein.

The terms “comprises,” “comprising,” or any other variations thereof, are intended to cover a non-exclusive inclusion, such that a setup, device that comprises a list of components does not include only those components but may include other components not expressly listed or inherent to such setup or device. In other words, one or more elements in a fertilizer composition or method proceeded by “comprises . . . a” does not, without more constraints, preclude the existence of other elements or additional elements in the composition or method.

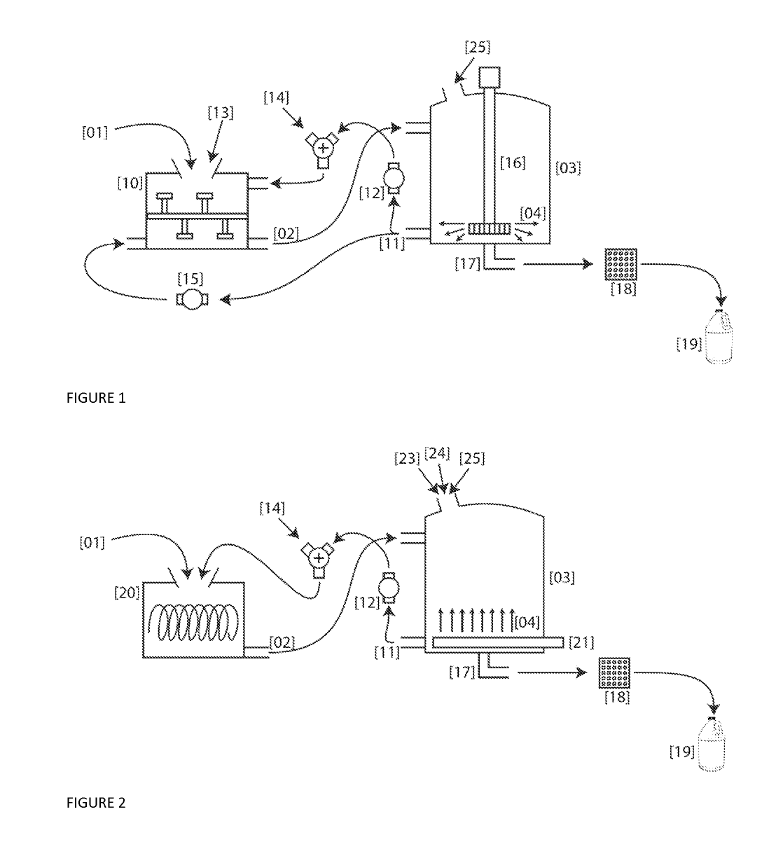

FIGS. 1-7 show exemplary embodiments used to make fish fertilizers. Each revolves around a main tank [03] into which high volumes of air [04] are injected. The figures show different stages used before and after the main tank to support the invention. Embodiments for creating fish fertilizer are discussed next with three processing stages:

### 1. First Stage

In this stage, fish source is broken into small particles (less than approximately 1 mm) through one of two processes. In one embodiment shown in FIG. 1, the source fish [01] may go through a primary fermentation in a food compost machine [10]. This device decomposes waste foods by gentle mixing of the food and having a base of bio-chips (porous material, often plastic cubes about 10 mm on a side) to facilitate the growth of microorganisms and mixing with oxygen. Microorganisms and enzymes [13] are added to the food compost machine to decompose the fish rapidly. Particles of the fish that are decomposed to a size less than 1 mm [02] exit the food compost machine through a mesh at its bottom. The food compost machine requires that the fish be sprayed with water and this can be a mixture of fresh potable water [14] and partially or fully decomposed fish fertilizer [11]. The partially or fully decomposed fish fertilizer [11] may need to be pumped with pump [12]. The ratio of the water to the fish fertilizer depends on the type of fish, but is typically 0% to 20% water. The reason for not using 100% water is to ensure that the final product is as concentrated as possible. The food compost machine requires a washout and this is accomplished with 100% partially or fully decomposed fish fertilizer [11] injected at high pressure using pump [15]. For expediency of the process, the fish may be broken into small pieces (about 5˜10 mm) before going into the food compost machine.

FIG. 2 shows a preferred embodiment, where the source fish [01] may go through a grinder [20]. This may be a single stage or two stages. A single stage would take the fish and directly create a paste (particle size of <1 mm) whereas a double stage grinder produces small pieces (about 5˜10 mm) from the first grinder and that output is fed to the second grinder that produces the paste (particle size <1 mm) [02].

The grinder [20] may need liquid to facilitate its operation. This liquid can be a mixture of fresh potable water [14] and partially or fully decomposed fish fertilizer [11]. The partially or fully decomposed fish fertilizer [11] may need to be pumped with pump [12].

### 2. Second Stage

The partially processed fish (particles less than 1 mm) [02] is then fed into a tank [03]. Depending on the type of fish, some water [24] may be added at this stage if method of FIG. 2 is used. The amount of water that is added is minimal and up to a maximum of 25% of the volume of the fish [02]. This ensures that the final product is as concentrated as possible.

Large volumes of air [04] are injected into the tank to make the fish decompose rapidly. This air is injected with an aerator [16] or a bubble generator [21]. The preferred embodiment is to use a self aspirating aerator, but an aerator driven by a separate air compressor may be used. The preferred embodiment is that the bubble generator be a micro-bubble generator, though a generator with small bubbles may be used with an external air compressor.

In one embodiment, the amount of air that is introduced is at least equal in volume to the volume of the tank [03] every hour. Typically, the amount of air that is added is more than three times the volume of the tank per hour. For example, if the tank is 3000 litre (3 m³), the amount of air added is 10 m³/h (2.8 l/s).

In another embodiment, the bubbles of air produced by the aerator or micro-bubble generator form a large surface area to allow the microorganisms to interact with the liquid. This accelerates the decomposition.

In another embodiment, the large volumes of air agitate the liquid and prevent solids from settling on the bottom of the tank.

In yet another embodiment, microorganisms and enzymes [23] may be added to the liquid to speed the fermentation process or the natural microorganisms in the fish may be relied upon to decompose the fish.

The fermentation process may take 24 to 96 hours depending on the type of fish, the initial temperature of the fish, the ambient temperature of the tank, the size of the tank, and the type of microorganisms and enzymes (if any) that are added to the process.

### 3. Third Stage—Version 1

In one embodiment, the tank [03] is filled and then it is left until fermentation has completed. No further fish [01] is added during this time and air [04] is continually injected during this process.

In one implementation, after fermentation, the liquid in the tank [03] is then mixed with an acid [25] to stabilize the fertilizer. This helps to kill off any remaining microorganisms and also reduce the pH of the product for transportation and storage. The fermentation process creates carbon dioxide and if this takes place after the fertilizer has left the factory, storage containers may rupture or explode.

In another implementation, the optimum balance for fertilizer is slightly acidic so the addition of acid at this stage prepares the fertilizer for direct use. The amount of acid [25] that is added depends on the pH of the current liquid; the intent is to bring the fertilizer to a pH of 4.5±0.5. The acid used is phosphorous acid (H3P03), phosphoric acid (H3PO4), or sulphuric acid (H2SO4). The advantage of using phosphorous acid (H3P03) or phosphoric acid (H3PO4) is that it adds phosphorous to the fertilizer which is needed by the plants.

### 4. Third Stage—Version 2

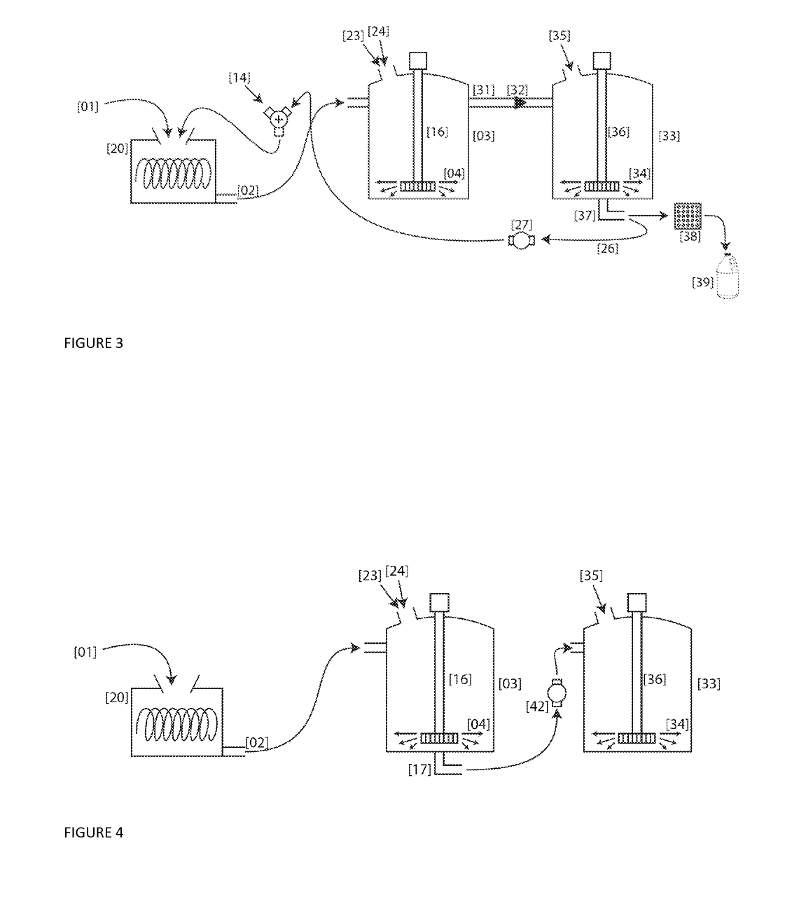

In one embodiment, one or more secondary tanks [33] are used to store the liquid and complete fermentation as shown in FIGS. 3, 4, 5, and 6. In this way, fish [01] is continually added to the process and the primary tank [03] overflows or is pumped to the secondary tank [33]. In FIG. 3 the output from the primary tank [03] flows through pipe [31]. The check valve [32] allows liquid to flow only in one direction. The overflow from tank [03] must be done while the air [04] is agitating the liquid in the first tank [03]. This ensures that only thoroughly mixed matter is sent to the secondary tank [33].

In one implementation, as one secondary tank is filled, the flow from the first tank [03] through pipe [31] is diverted automatically or manually to another secondary tank. The number of tanks that are required is dependent on the flow rate of fish [01] in unit time and the fermentation period. For example, if the flow rate of fish is 500 kg per hour, then the amount of matter [02] plus the amount of water [14 or 24] going to the tank [03] is about 500 liters per hour. If the secondary tank [33] is 3000 liters, it will fill in six hours. If the fermentation time is 42 hours, then seven such tanks are required to accommodate the output from the first tank [03].

In another implementation, this more complex form of my invention is referred to as “continuous fermentation” and involves the optional periodic adding of microorganisms [23] only to one tank as they will flow through the pipe [31] to the secondary tank(s) [33].

In yet another implementation, each secondary tank [33] has its own supply of air [34]. Again, this is introduced with the same vigor and methods as the air [04] introduced in the primary tank [03] as described in Section 2. This air [34] continues to agitate the liquid and mix oxygen with it to speed the fermentation.

In a further implementation, once fermentation in a secondary tank is complete, acid [35] is added to the secondary tank [33] in the same manner as described Third Stage—Form 1 of Section 3.

### 5. Packaging

In Form 1 the finished product is taken from the primary tank [03] as shown in FIG. 2. In Form 2, the finished product is taken from each of the secondary tank(s) [33] as shown in FIG. 3. Just before packaging, the air [04 or 34] is stopped. The liquid is drained from the bottom of the tank through pipe [17 or 37]. The liquid is passed through a filter [18 or 38]. The filter is designed to pass matter that is only 75 μm or smaller. This ensures that the fertilizer product can be sprayed through commercial or industrial crop sprayers without blocking the nozzles. After the filter, the fertilizer is put into containers [19 or 39] for distribution.

### 6. Different Ways to Connect the Tanks

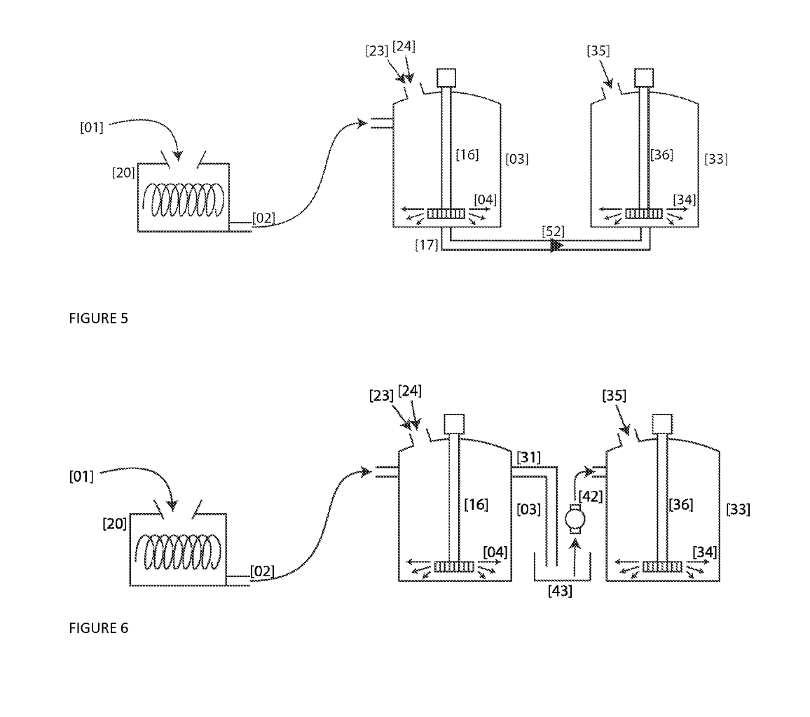

Although the easiest way to connect the tanks may be to take the output from one tank near the top of the tank and feed it to the next tank as shown in FIG. 3, it is possible to take the output from the bottom of a tank and feed it to the next tank. This could be accomplished as shown in FIG. 4 or FIG. 5. In FIG. 4, the output is taken from the bottom of the first tank [03] through exit pipe [17]. A pump [42] is used to pump the liquid into the top of the next tank [33]. In FIG. 5, the liquid exits the bottom of tank [03] through pipe [17] and flows into tank [33] through check valve [52]. In this case, there may be a manual or automatic control on the check valve [52] so that it is open only when the liquid reaches certain levels in the first tank [03] and the second tank [33]. Another method of connecting the tanks is shown in FIG. 6 where the output from tank [03] flows into an intermediate tank [43]. From there, it is pumped with pump [42] to tank [33].

The food compost machine [10] or the grinder [20] may need liquid to facilitate its operation. With a single tank [03] partially of fully decomposed fish fertilizer can be taken from tank [03] through pipe [11] for this purpose as shown in FIGS. 1 and 2. With a secondary tank, this liquid may be taken from the secondary tank [33] through pipe [37] as shown in FIG. 3. The liquid may need to be pumped with pump 27.

### Other Embodiments

Air can be used to provide oxygen to the microorganisms and also to perform the agitation. Air contains 21% oxygen but could be substituted with any gas that contains sufficient oxygen, or could be pure oxygen. Therefore, the gas can contain at least 5% oxygen is used by the aerator or micro-bubble generator.

The foregoing describes a process where the aerator or micro-bubble generator is continually injecting air and causing agitation. The aerator or micro-bubble generator operates in a continual mode, and not continuous mode, as it may be advantageous to stop the addition of oxygen periodically. This would cause microorganisms to use the oxygen they have available to digest the fish and at the same time to generate heat. After a predetermined time, air can be injected. In one embodiment, this turning on and off could be done anywhere from a few minutes on and a few minutes off to a few hours on and a few hours off (though the times do not need to be equal). Thus, the process of injection of air is not always continuously done.

Whole fish or fish parts can be used to create the fertilizer. However, other organic materials can be added to the process and may actually make a better fertilizer by its addition. Examples could be seaweed, leaves, or grasses. In the right physical location, these may be readily available at low cost. For example, a fish processing company located by the sea may have access to large volumes of seaweed. Or such a company may have a fish farm that is located next to fields where grasses grow. The inventor contemplates that the present system works with a wide range of materials where only a portion of the content by weight is fish.

To handle large volumes of fish (and hence to create large volumes of fish fertilizer), the process needs large tanks, many tanks, or a combination. One implementation uses tanks that contain about 3000 litre (3 m³). The tank is preferably cylindrical and installed vertically with the motor mounted on top and the shaft of the aerator into the liquid. It is hard to make such a shaft longer than 2.5 m. The turbine of the aerator typically needs to be no more than about 0.5 m above the base of the tank and that therefore limits the height of the tank. The diameter could be 3.5 m in one embodiment. One embodiment uses a tank size of 25,000 liters (25 m³) and as 1 kg of fish makes about 1 liter of fish fertilizer, one of these tanks is filled with 25 ton of fish. In many places, that is the amount available in a day. The fermentation can take several days so several of these big tanks are needed in a large facility.

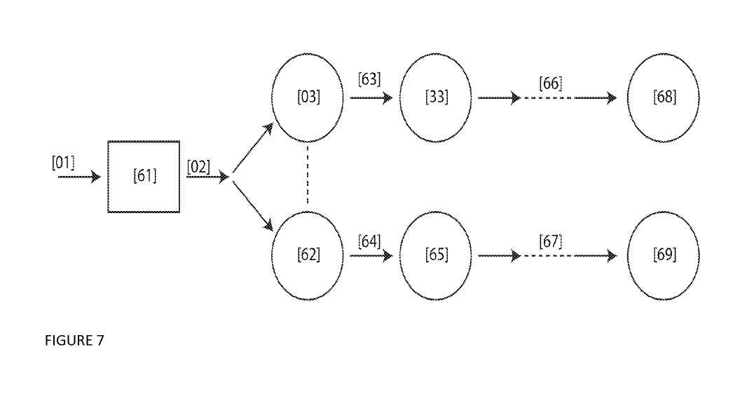

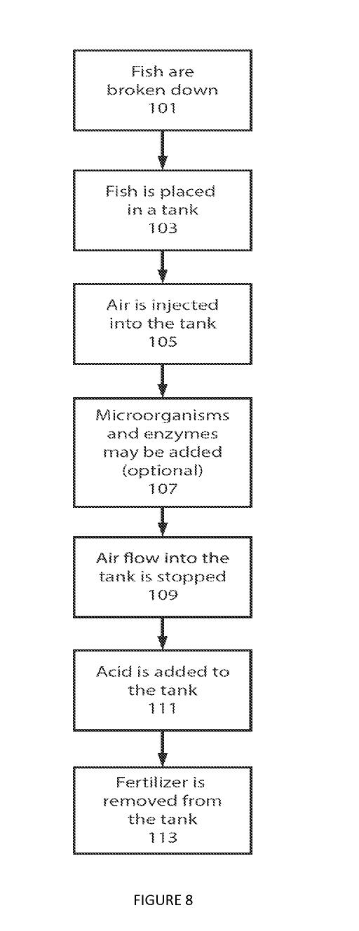

A single tank can be used as shown in FIGS. 1-2 or two tanks can be used as shown in FIG. 3. However, it is possible to use multiple tanks either in series or in parallel as shown in FIG. 7.

Referring to FIG. 7, in this embodiment the fish [01] is fed into the food compost machine or grinder [61] (these are depicted as [10] on FIG. 1 and [20] on FIG. 2, and either may be used). The output [02] is fed to the first tank [03]. From this first tank, the partially fermented liquid is sent to a secondary tank [33] through pipe and valve [63] (this is shown on FIG. 3 as pipe [31] and check valve [32], on FIG. 4 as pipe [17] and pump [42], on FIG. 5 as pipe [17] and check valve [52], and on FIG. 6 as pipe [31], tank [43], and pump [42]).

The output from tank [33] may flow to one or more tanks [66] to [68], with the output from tank [68] being used to go to the packaging process. The tanks [66] to [68] may or may not have air injected in them. They may just use a mechanical agitator to distribute the liquid and aid final fermentation.

The output from food compost machine or grinder [61] may simultaneously or alternately be fed to a parallel tank or set of tanks [62], [65], to [67], and [69]. In each case, the output is sent through a pipe and check valve or pump [64]. The finished fertilizer sent to packaging is always taken from the last tank in the series [68] and [69]. The outputs from these tanks could be merged to a single packaging process or sent to separate packaging processes. (For simplicity the packaging is not shown in FIGS. 4-7.)

There could possibly be multiple tanks in parallel and they could be arranged so there are any number from as few as one or as many as 16 tanks in each series. The tanks could be connected in any manner as described in the figures.

FIG. 8 shows an exemplary process for making fertilizer from fish. First, the fish are reduced into small particles [101] and placed in a tank [103]. Air is then injected into the tank [105]. Microorganisms and enzymes may optionally be added to the tank as desired [107]. Air flow into the tank is periodically stopped [109], and acid can be added into the tank [111] to help form the fertilizer. Upon completion, the fertilizer is removed from the tank [113].

The advantages of the present invention can be achieved in an economical, practical, and facile manner. While preferred aspects and example configurations have been shown and described, it is to be understood that various further modifications and additional configurations will be apparent to those skilled in the art. It is intended that the specific embodiments and configurations herein disclosed are illustrative of the preferred nature of the invention, and should not be interpreted as limitations on the scope of the invention. While various embodiments of the invention have been described above, it should be understood that they have been presented by way of example only, and not by way of limitation. Although the disclosure is described above in terms of various exemplary embodiments and implementations, it should be understood that the various features and functionality described in one or more of the individual embodiments are not limited in their applicability to the particular embodiment with which they are described. They instead can be applied, alone or in some combination, to one or more of the other embodiments of the disclosure, whether or not such embodiments are described, and whether or not such features are presented as being a part of a described embodiment. Thus the breadth and scope of the present disclosure should not be limited by any of the above-described exemplary embodiments.

All references cited herein are incorporated herein by reference in their entirety. To the extent publications and patents or patent applications incorporated by reference contradict the disclosure contained in the specification, the specification is intended to supersede or take precedence over any such contradictory material.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term” “including” should be read to mean “including, without limitation,” “including but not limited to,” or the like; the term “comprising” as used herein is synonymous with “including,” “containing,” or “characterized by,” and is inclusive or open-ended and does not exclude additional, unlisted elements or method steps; the term “having” should be interpreted as “having at least;” the term “includes” should be interpreted as “includes but is not limited to;” the term “example” is used to provide exemplary instances of the item in discussion, not an exhaustive or limiting list thereof; adjectives such as “known,” “normal,” “standard,” and terms of similar meaning should not be construed as limiting the item described to a given time period or to an item available as of a given time, but instead should be read to encompass known, normal, or standard technologies that may be available or known now or at any time in the future; and use of terms like “preferably,” “preferred,” “desired,” or “desirable,” and words of similar meaning should not be understood as implying that certain features are critical, essential, or even important to the structure or function of the invention, but instead as merely intended to highlight alternative or additional features that may or may not be utilized in a particular embodiment of the invention. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise.

With respect to the use of substantially any plural or singular terms herein, those having skill in the art can translate from the plural to the singular or from the singular to the plural as is appropriate to the context or application. The various singular/plural permutations may be expressly set forth herein for sake of clarity.

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All numbers expressing quantities of ingredients, reaction conditions, and so forth used in the specification are to be understood as being modified in all instances by the term “about.” Accordingly, unless indicated to the contrary, the numerical parameters set forth herein are approximations that may vary depending upon the desired properties sought to be obtained. At the very least, and not as an attempt to limit the application of the doctrine of equivalents to the scope of any claims in any application claiming priority to the present application, each numerical parameter should be construed in light of the number of significant digits and ordinary rounding approaches.

Furthermore, although the foregoing has been described in some detail by way of illustrations and examples for purposes of clarity and understanding, it is apparent to those skilled in the art that certain changes and modifications may be practiced. Therefore, the description and examples should not be construed as limiting the scope of the invention to the specific embodiments and examples described herein, but rather to also cover all modification and alternatives coming with the true scope and spirit of the invention.

What is claimed is:

1. A method for forming a fertilizer based on fish, comprising:
decomposing or grinding fish parts into a fish paste;
depositing the fish paste into a tank;
injecting air into the tank to form bubbles to agitate the fish paste and to accelerate decomposition of the fish paste; and
adding acid to the fish paste after fermenting the fish paste to form the fertilizer.

2. The method of claim 1, comprising adding water to the paste in the tank.

3. The method of claim 1, comprising injecting air with an aerator or a micro-bubble generator.

4. The method of claim 1, wherein air injected into the tank is equal to a tank volume every hour.

5. The method of claim 1, wherein air injected into the tank is equal to three times a tank volume every hour.

6. The method of claim 1, comprising adding a microorganism or an enzyme to speed the fermenting of the fish paste.

7. The method of claim 1, comprising stopping air injection prior to packaging the fertilizer.

8. The method of claim 1, wherein the decomposing comprises
mixing the fish parts with a base of bio-chips; and
facilitating growth of micro-organisms with the bio-chips and oxygen.

9. A system to make fertilizer based on fish, comprising:
a food compost machine to receive fish parts, mix the fish parts with a base of bio-chips, and facilitate growth of micro-organisms with the bio-chips and oxygen, said food compost machine forming a fish paste; and
a tank receiving the fish paste from the food compost machine, said tank has bubbles of air injected to agitate the fish paste and to accelerate decomposition of the fish paste into the fertilizer based on fish.

10. The system of claim 9, comprising a micro-bubble generator to inject air.

11. The system of claim 9, comprising an aerator to inject air.

12. The system of claim 9, comprising a filter to separate particles from the fertilizer concentrate.

13. The system of claim 9, wherein the tank comprises a port to receive microorganisms or enzymes to speed the fermenting of the fish paste or an acid to stabilize the fermentation.

14. The system of claim 9, comprising a second tank coupled to the first tank to ferment the fish paste.

15. The system of claim 9, comprising a plurality of tanks coupled to the food compost machine in serial or in parallel to ferment the fish paste.

16. A system to make fertilizer based on fish, comprising:
a grinder to receive fish parts and form a fish paste there from; and
a tank receiving the fish paste from the grinder, said tank has bubbles of air injected to agitate the fish paste and to accelerate decomposition of the fish paste into the fertilizer based on fish.

17. The system of claim 16, comprising a micro-bubble generator to inject air.

18. The system of claim 16, comprising an aerator to inject air.

19. The system of claim 16, comprising a filter to separate particles from the fertilizer concentrate.

20. The system of claim 16, wherein the tank comprises a port to receive microorganisms or enzymes to speed the fermenting of the fish paste or an acid to stabilize the fermentation.

21. The system of claim 16, comprising a second tank coupled to the first tank to ferment the fish paste.

22. The system of claim 16, comprising a plurality of tanks coupled to the grinder in serial or in parallel to ferment the fish paste.
